(19) United States
(12) Patent Application Publication
(10) Pub. No.: US 2026/0255150 A1
(43) Pub. Date: Aug. 27, 2026

(54) LINK RECONFIGURATION REQUEST AND RESPONSE ENHANCEMENTS FOR SEAMLESS ROAMING

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/549,882

(22) Filed: Feb. 25, 2026

Related U.S. Application Data
(60) Provisional application No. 63/764,227, filed on Feb. 27, 2025.
(60) Provisional application No. 63/763,115, filed on Feb. 25, 2025.

(51) Int. Cl. H04W 8/14; H04W 76/15

(52) U.S. Cl. CPC H04W 8/14; H04W 76/15

(57) ABSTRACT

Described herein is a network that uses enhanced link reconfiguration requests and link reconfiguration responses to perform seamless roaming. A first AP MLD performs an operation that includes receiving, from a non-AP MLD, a first link reconfiguration request that includes a first multi-link element that indicates a second AP MLD in a SMD of the first AP MLD and that indicates one or more links requested to be added at the second AP MLD for roaming preparation, a first roaming phase indication that indicates a roaming preparation phase, and a roaming request control indicating roaming context information from the non-AP MLD for roaming preparation at the second AP MLD. The operation also includes, based on the first link reconfiguration request, requesting the second AP MLD to initiate roaming preparation using the first multi-link element, the first roaming phase indication, and the roaming request control.

### CROSS-REFERENCE TO RELATED APPLICATIONS

This application claims benefit of co-pending United States provisional patent application Serial No. 63/763,115 filed February 25, 2025 and co-pending United States provisional patent application Serial No. 63/764,227 filed February 27, 2025. The aforementioned related patent applications are herein incorporated by reference in their entirety.

### TECHNICAL FIELD

Embodiments presented in this disclosure generally relate to wireless communication. More specifically, embodiments disclosed herein relate to link reconfiguration request and response enhancements for seamless roaming.

### BACKGROUND

Link reconfiguration is a procedure that allows a non-access point multi-link device (non-AP MLD) (which may also be referred to as a device or client) to reconfigure its set of links (e.g., add a link, delete a link, etc.) with an access point multi-link device (AP MLD) (which may also be referred to as an access point) without reassociating with the AP MLD (e.g., by exchanging link reconfiguration requests and responses with the access point). Seamless roaming is a procedure that allows the non-AP MLD to quickly roam between AP MLDs in a seamless mobility domain (SMD). Generally, seamless roaming involves a target AP MLD adding links for a non-AP MLD that will soon roam to the target AP MLD.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates the system of FIG. 1A.

FIG. 1C illustrates an example network controller, access point, or device in the system of FIG. 1A.

FIG. 2 illustrates an example operation performed by the system of FIG. 1A.

FIGS. 3A and 3B illustrate example messages in the system of FIG. 1A.

FIGS. 4A and 4B illustrate example messages in the system of FIG. 1A.

FIG. 5 illustrates an example operation performed by the system of FIG. 1A.

FIG. 6 illustrates an example message in the system of FIG. 1A.

FIG. 7 illustrates an example message in the system of FIG. 1A.

FIG. 8 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that uses enhanced link reconfiguration requests and link reconfiguration responses to perform seamless roaming. According to an embodiment, a first AP MLD includes one or more memories and one or more processors communicatively coupled to the one or more memories. The one or more processors, individually or collectively, perform an operation that includes receiving, from a non-AP MLD, a first link reconfiguration request that includes a first multi-link element that indicates a second AP MLD in a SMD of the first AP MLD and that indicates one or more links requested to be added at the second AP MLD for roaming preparation, a first roaming phase indication that indicates a roaming preparation phase, and a roaming request control indicating roaming context information from the non-AP MLD for roaming preparation at the second AP MLD. The operation also includes, based on the first link reconfiguration request, requesting the second AP MLD to initiate roaming preparation using the first multi-link element, the first roaming phase indication, and the roaming request control.

According to another embodiment, a method includes receiving, by a first AP MLD and from a non-AP MLD, a first link reconfiguration request that includes a first multi-link element that indicates a second AP MLD in a SMD of the first AP MLD and that indicates one or more links requested to be added at the second AP MLD for roaming preparation, a first roaming phase indication that indicates a roaming preparation phase, and a roaming request control indicating roaming context information from the non-AP MLD for roaming preparation at the second AP MLD. The method also includes, based on the first link reconfiguration request, requesting, by the first AP MLD, the second AP MLD to initiate roaming preparation using the first multi-link element, the first roaming phase indication, and the roaming request control.

According to another embodiment, a non-transitory computer readable medium stores instructions that, when executed, cause one or more processors to, individually or collectively, perform an operation that includes receiving, by a first AP MLD and from a non-AP MLD, a first link reconfiguration request that includes a first multi-link element that indicates a second AP MLD in a SMD of the first AP MLD and that indicates one or more links requested to be added at the second AP MLD for roaming preparation, a first roaming phase indication that indicates a roaming preparation phase, and a roaming request control indicating roaming context information from the non-AP MLD for roaming preparation at the second AP MLD. The operation also includes, based on the first link reconfiguration request, requesting, by the first AP MLD, the second AP MLD to initiate roaming preparation using the first multi-link element, the first roaming phase indication, and the roaming request control.

### EXAMPLE EMBODIMENTS

Because seamless roaming involves a target access point multi-link device (AP MLD) (which may also be referred to as an access point) adding links for a non-access point multi-link device (non-AP MLD) (which may also be referred to as a device or client) that may roam to the target AP MLD, it may be possible to use enhanced versions of link reconfiguration requests and link reconfiguration responses to implement a seamless roam.

The present disclosure describes a network that uses enhanced link reconfiguration requests and link reconfiguration responses to perform seamless roaming. Generally, a non-AP MLD may communicate a link reconfiguration request to a serving AP MLD to request to roam to a target AP MLD. The link reconfiguration request may identify the target AP MLD and indicate a roam request (or a roaming preparation request) to prepare a target AP MLD for roaming. The serving AP MLD may communicate a roaming context transfer request to the target AP MLD, and the target AP MLD may add or establish one or more links for the non-AP MLD (and may reserve resources for the non-AP MLD). The serving AP MLD may communicate a link reconfiguration response to the non-AP MLD to indicate whether the links were setup for the non-AP MLD at the target AP MLD, and based on the indication, the non-AP MLD may execute the roam to the target AP MLD.

To execute the roam, the non-AP MLD may communicate another link reconfiguration request to the serving AP MLD indicating that the non-AP MLD is executing roaming to the target AP MLD. The serving AP MLD may communicate a roaming context transfer request to the target AP MLD, and the target AP MLD may activate the links that were setup for the non-AP MLD in the roaming preparation, which may involve opening or unblocking an IEEE 802.1X controlled port and initiating a distribution system (DS) mapping change for the non-AP MLD. The serving AP MLD may communicate a link reconfiguration response to the non-AP MLD to indicate that completion of roaming execution with the target AP MLD. The non-AP MLD may then roam or transition to the target AP MLD.

In some embodiments, a link reconfiguration request may include additional elements or fields. As a first example, the link reconfiguration request may include a seamless mobility domain element (SMDE) or SMD Information element (SMD IE) that provides a media access control (MAC) address of a seamless mobility domain (SMD) or an SMD Identifier. In some embodiments, the SMDE may not be included if a ultra high reliability (UHR) variant of the link reconfiguration request is used, because the UHR variant frame may be sent for SMD roaming operation. As another example, the link reconfiguration request may include an IE (e.g., called roaming request control (or another name)) that provides configurations for different roaming options for roaming preparation and roaming execution. As another example, the link reconfiguration request may include a field that indicates either roaming preparation or roaming execution operation type for roaming request and is set to the appropriate type based on which roaming phase (roaming preparation or roaming execution) is being performed using the link reconfiguration request. As another example, the link reconfiguration request may include one or more reconfiguration multi-link (ML) elements. As another example, the link reconfiguration request may include a presence of some subelements (e.g., called context renegotiation parameters subelements) which may include context parameters that should be renegotiated as part of roaming preparation or roaming execution. As another example, the link reconfiguration request may include a field in the reconfiguration ML element in common info to identify the target AP MLD, or the link reconfiguration request may use the existing multi-link (MLD) MAC address to signal the target AP MLD MAC address. There may be two options for the format of the link reconfiguration request. In a first option, the roaming request control (or another element) provides configuration for each request option and if not applicable, the field or bits are reserved. In a second option, the roaming request control (or another element) includes a presence bitmap that may indicate the presence of different request options. A particular request option may be included if the corresponding presence bit is set to 1 (e.g., similar to presence bit indication used in basic ML element).

In particular embodiments, a link reconfiguration response may include additional elements or fields. As a first example, the link reconfiguration response may include an SMD IE or another IE or field that provides an SMD MAC address or SMD identifier. In another example, the link reconfiguration response includes an IE or field (e.g., called roaming response control (or another name)) that provides the status or outcome and other roaming parameters for different roaming options or configurations indicated in the link reconfiguration request frame. As another example, the link reconfiguration response may include a field that indicates either roaming preparation or roaming execution operation type for roaming response and is set to the appropriate type based on which roaming phase (roaming preparation or roaming execution) is being performed using the link reconfiguration response. As another example, the link reconfiguration response may include a target AP MLD MAC address for each target AP MLD for which status or other roaming parameters are provided. In another example, the link reconfiguration response includes an association identifier (AID) field that provides the AID assigned to the non-AP MLD by the target AP MLD. As another example, the link reconfiguration response may include status info for multiple target AP MLDs if the non-AP MLD is performing roaming preparation for multiple target AP MLDs using a single roaming preparation request. The link reconfiguration response may include a count field which indicates a number of roaming response control IEs or fields, one for each target AP MLD. In another example, the link reconfiguration response may include multiple instances of group key data provided at the roaming preparation phase, one for each prepared target AP MLD. Additionally or alternatively, the group key data may not be provided in the link reconfiguration response that is sent as a roaming preparation response because group key data may be provided as part of roaming execution phase to the non-AP MLD. The group key data may be provided in the roaming execution response for the one target AP MLD to which the non-AP MLD is roaming. The group key data provides group keys (e.g., group temporal key (GTK), integrity group temporal key (IGTK), beacon integrity group temporal key (BIGTK)) for accepted links of the target AP MLD. As another example, the link reconfiguration response may include one or more Basic ML elements to provide a list of accepted links for target AP MLD(s) (one Basic ML element is included for each target AP MLD when roaming preparation is performed for multiple target AP MLDs). Similar to the link reconfiguration request discussed above, there may be two options for the format of the link reconfiguration response. A first option may provide status info for each requested roaming option or configuration, and a second option may use a presence bitmap to indicate the status of the requested option or configuration (as requested in the corresponding link reconfiguration request).

In some examples, the link reconfiguration request and the link reconfiguration response may include other information. For example, the link reconfiguration request and the link reconfiguration response may include an operating channel information (OCI) element. As another example, the link reconfiguration request and the link reconfiguration response may include a roaming sequence number or another token or some roaming related identifier across the roaming preparation and the roaming execution phases to tie these exchanges to the same seamless roaming procedure. A field included in the roaming request control (or another element) in the link reconfiguration request or a field included in the roaming response control (or another element) in the link reconfiguration response may include the roaming sequence number, token, or roaming related identifier. Some fields in the roaming request control and the roaming response control may apply to only the roaming preparation phase, and some other fields may apply to only the roaming execution phase.

In certain embodiments, the network provides several technical advantages. For example, the network may allow a non-AP MLD to perform seamless roaming using link reconfiguration requests and responses. As another example, the network may allow the device to indicate several target AP MLD candidates for the seamless roam.

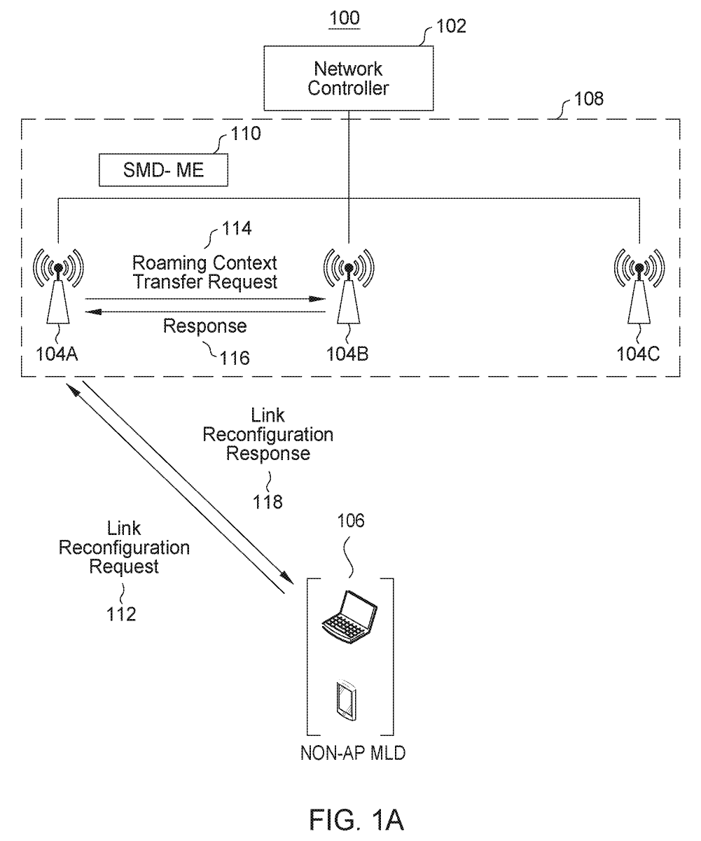

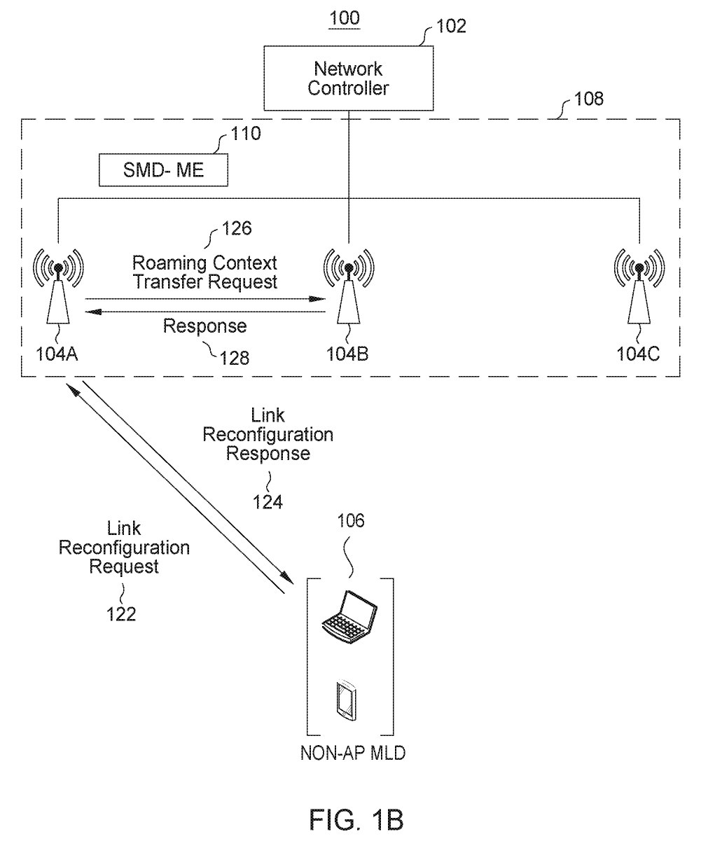

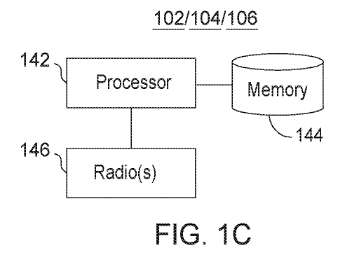

FIG. 1A illustrates an example system 100. As seen in FIG. 1A, the system 100 includes a network controller 102, AP MLDs 104 (e.g., AP MLDs 104A, 104B, and 104C) and one or more non-AP MLDs 106. The AP MLDs 104 may be part of an SMD 108, and the non-AP MLD 106 is associated with an SMD management entity (SMD-ME) 110 of the SMD 108. Generally, the system 100 allows the AP MLDs 104 and the non-AP MLD 106 to use link reconfiguration requests and link reconfiguration responses to perform roaming preparation.

The network controller 102 facilitates or manages the communication in the system 100. As an example, the network controller 102 may manage the connections between the AP MLDs 104 and the non-AP MLD 106. As another example, the network controller 102 may manage the connections and traffic between the AP MLDs 104.

An AP MLD 104 may be a network device that facilitates wireless communication (e.g., Wi-Fi communication) in the system 100. The non-AP MLD 106 connects to the AP MLD 104, and the AP MLD 104 may facilitate communication to and from the non-AP MLD 106. For example, the AP MLD 104 may receive messages from the non-AP MLD 106 and direct those messages towards their destination. As another example, the AP MLD 104 may receive messages intended for the non-AP MLD 106 and direct those messages to the non-AP MLD 106. The AP MLD 104 may also exchange messages with the network controller 102 or with other AP MLDs 104. Multiple AP MLDs 104 may be implemented in the same physical access point.

A non-AP MLD 106 may be any suitable device for communicating with components of the system 100. As an example and not by way of limitation, the non-AP MLD 106 may be a computer, a laptop, a wireless or cellular telephone, an electronic notebook, a personal digital assistant, a tablet, or any other device capable of receiving, processing, storing, or communicating information with other components of the system 100. The non-AP MLD 106 may be a wearable device such as a virtual reality or augmented reality headset, a smart watch, or smart glasses. The non-AP MLD 106 may also include a user interface, such as a display, a microphone, keypad, or other appropriate terminal equipment. The non-AP MLD 106 may include a hardware processor, memory, or circuitry configured to perform any of the functions or actions of the non-AP MLD 106 described herein. For example, a software application designed using software code may be stored in the memory and executed by the processor to perform the functions of the non-AP MLD 106. Multiple non-AP MLDs 106 may be implemented in the same physical device.

The non-AP MLD 106 may roam between AP MLDs 104 in the system 100, which are part of the same SMD 108. For example, the non-AP MLD 106 may initially be connected through the AP MLD 104A. If the non-AP MLD 106 moves further from the AP MLD 104A and closer to the AP MLD 104B, the non-AP MLD 106 may determine that the non-AP MLD 106 should roam from the AP MLD 104A to the AP MLD 104B for an improved connection (possibly with some help in discovering suitable candidates for roaming from the AP MLD 104A and/or network controller 102). The non-AP MLD 106 may then communicate a roaming request (e.g. a roaming preparation request) to the AP MLD 104A, and the AP MLD 104A may communicate with the AP MLD 104B to prepare for the roam. When roaming preparation is complete, the non-AP MLD 106 may execute the roam from the AP MLD 104A to the AP MLD 104B.

An AP MLD 104 and the non-AP MLD 106 may use link reconfiguration requests and link reconfiguration responses to adjust the links used by the AP MLD 104 and the non-AP MLD 106. The AP MLD 104 and the non-AP MLD 106 may also use link reconfiguration requests and link reconfiguration responses to perform seamless roaming (also known as SMD roaming or SMD basic service set (BSS) transition (ST)). The link reconfiguration requests may operate as roaming requests for roaming preparation and roaming execution procedures, and the link reconfiguration responses may operate as roaming responses for roaming preparation and roaming execution procedures.

In the example of FIG. 1A, the non-AP MLD may initiate a roam from the AP MLD 104A to the AP MLD 104B by communicating a link reconfiguration request 112 to the AP MLD 104A, which indicates a request to prepare a target AP MLD for seamless roaming. The link reconfiguration request 112 may request that the AP MLD 104B (e.g., a target AP MLD for roaming preparation) add one or more links for the non-AP MLD 106 as part of roaming preparation. The link reconfiguration request 112 may be a UHR link reconfiguration request (a UHR variant of a link reconfiguration request) and may include elements that are not included in traditional link reconfiguration requests. For example, the link reconfiguration request 112 may include an SMDE that identifies the SMD 108 to which the AP MLD 104A and the AP MLD 104B belong. In some embodiments the SMDE may not be included in a UHR link reconfiguration request. As another example, the link reconfiguration request 112 may include a Multi-Link element (e.g., a Reconfiguration Multi-Link element) that identifies the target AP MLD 104B (e.g., a MAC address of the AP MLD 104B) and includes a set of links to be added (and related parameters) at the target AP MLD 104B for roaming preparation. As another example, the link reconfiguration request 112 may include a field indicating the type of roaming operation to be roaming preparation and may further include a roaming request control (or another element name) indicating configurations for different roaming options that the non-AP MLD 106 is requesting to prepare the AP MLD 104B for seamless roaming.

The AP MLD 104A may communicate some of the information in the link reconfiguration request 112 to the AP MLD 104B in a roaming context transfer request 114. The AP MLD 104B may then perform roaming preparation (e.g., by setting up one or more links for the non-AP MLD 106, reserving resources such as for stream classification services (SCS) and Block Acknowledgement for the non-AP MLD 106) using the information in the roaming context transfer request 114. The AP MLD 104B may then communicate a response 116 to the AP MLD 104A to indicate that roaming preparation is complete.

The AP MLD 104A may then communicate a link reconfiguration response 118 to the non-AP MLD 106 to indicate that roaming preparation is complete. The link reconfiguration response 118 may be a UHR link reconfiguration response (a UHR variant of a link reconfiguration response) and may include elements that are not included in traditional link reconfiguration responses. For example, the link reconfiguration response 118 may include an SMDE that identifies the SMD 108 to which the AP MLD 104A and AP MLD 104B belong. In some embodiments the SMDE may not be included in a UHR link reconfiguration response. As another example, the link reconfiguration response 118 may include a Multi-Link element (e.g., a Basic ML element) that identifies the set of links that are setup at the AP MLD 104B. As another example, the link reconfiguration response 118 may include a field indicating the type of roaming operation to be roaming preparation and may further include a roaming response control (or another element name) that indicates an outcome/status of the non-AP MLD 106 request to prepare the AP MLD 104B for roaming.

At a subsequent time, the non-AP MLD 106 may initiate roaming execution to execute the roam to the AP MLD 104B. FIG. 1B illustrates the example system 100 of FIG. 1A performing roaming execution. The non-AP MLD 106 may use a similar process for performing roaming execution as roaming preparation. The non-AP MLD 106 may communicate a link reconfiguration request 122 (which may include a UHR link reconfiguration request) to the AP MLD 104A to initiate the roaming execution. The AP MLD 104A may communicate a roaming context transfer request 126 to the AP MLD 104B to indicate that roaming execution is beginning. The roaming context transfer request 126 for roaming execution may carry fields and parameters related to roaming execution (e.g., a field indicating roaming execution and dynamic context information (such as sequence number (SN) and packet number (PN)) for the non-AP MLD 106). The AP MLD 104B may activate the previously added links for the non-AP MLD 106, which may involve opening or unblocking an IEEE 802.1X controlled port and initiating a DS mapping change for the non-AP MLD 106. The AP MLD 104B may communicate a response 128 to the AP MLD 104A indicating that the AP MLD 104B has completed roaming execution and is ready to connect with the non-AP MLD 106. The AP MLD 104A may then communicate a link reconfiguration response 124 (which may include a UHR link reconfiguration response) to the non-AP MLD 106 to indicate that the AP MLD 104B has completed roaming execution and is ready to connect with the non-AP MLD 106. The non-AP MLD 106 may then transition to the AP MLD 104B.

FIG. 1C illustrates an example network controller 102, AP MLD 104, or non-AP MLD 106 of the system 100 of FIG. 1A. As seen in FIG. 1B, the network controller 102, AP MLD 104, or non-AP MLD 106 includes a processor 142, a memory 144, and one or more radios 146.

The processor 142 is any electronic circuitry, including, but not limited to one or a combination of microprocessors, microcontrollers, application specific integrated circuits (ASIC), application specific instruction set processor (ASIP), or state machines, that communicatively couples to the memory 144 and controls the operation of the network controller 102, AP MLD 104, or non-AP MLD 106. The processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 142 may include other hardware that operates software to control and process information. The processor 142 executes software stored on the memory 144 to perform any of the functions described herein. The processor 142 controls the operation and administration of the network controller 102, AP MLD 104, or non-AP MLD 106 by processing information (e.g., information received from the memory 144 and radios 146). The processor 142 is not limited to a single processing device and may encompass multiple processing devices contained in the same device or computer or distributed across multiple devices or computers. The processor 142 is considered to perform a set of functions or actions if the multiple processing devices collectively perform the set of functions or actions, even if different processing devices perform different functions or actions in the set.

The memory 144 may store, either permanently or temporarily, data, operational software, or other information for the processor 142. The memory 144 may include any one or a combination of volatile or non-volatile local or remote devices suitable for storing information. For example, the memory 144 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 144, a disk, a CD, or a flash drive. In particular embodiments, the software may include an application executable by the processor 142 to perform one or more of the functions described herein. The memory 144 is not limited to a single memory and may encompass multiple memories contained in the same device or computer or distributed across multiple devices or computers. The memory 144 is considered to store a set of data, operational software, or information if the multiple memories collectively store the set of data, operational software, or information, even if different memories store different portions of the data, operational software, or information in the set.

The radios 146 may communicate messages or information using different communication technologies. For example, the network controller 102, AP MLD 104, or non-AP MLD 106 may use one or more of the radios 146 for Wi-Fi communications. The network controller 102, AP MLD 104, or non-AP MLD 106 may use one or more of the radios 146 to transmit messages and one or more of the radios 146 to receive messages. The network controller 102, AP MLD 104, or non-AP MLD 106 may include any number of radios 146 to communicate using any number of communication technologies.

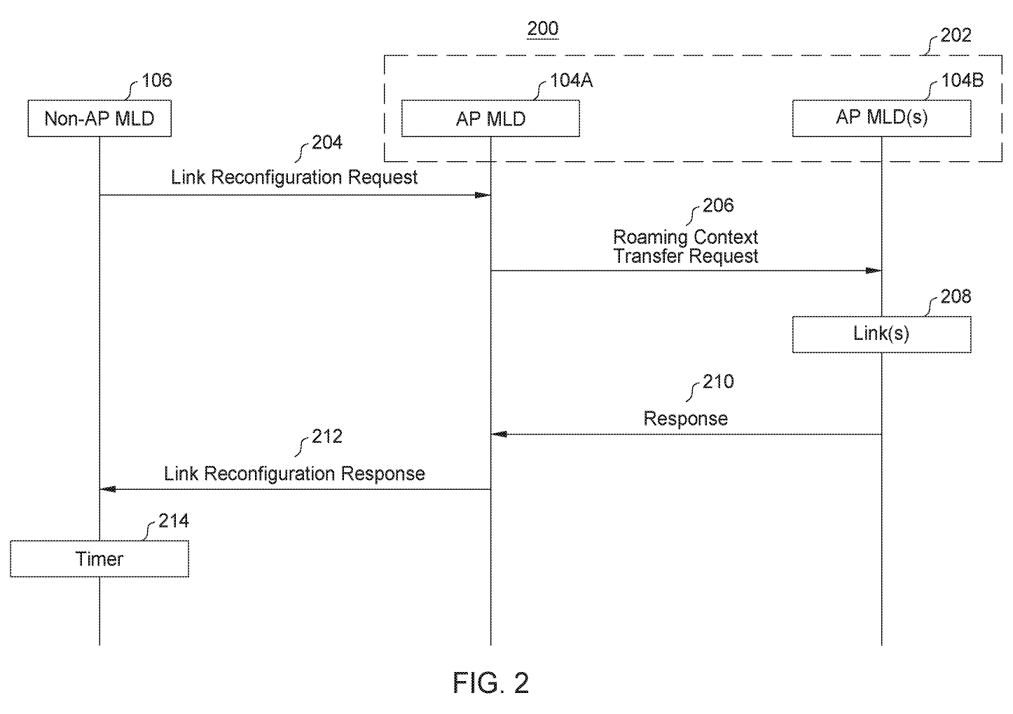

FIG. 2 illustrates an example operation 200 performed by the system 100 of FIG. 1A. As seen in FIG. 2, the non-AP MLD 106, the AP MLD 104A, and the AP MLD 104B perform the operation 200. By performing the operation 200, the non-AP MLD 106, the AP MLD 104A, and the AP MLD 104B use link reconfiguration requests and responses to perform roaming preparation.

The non-AP MLD 106 may be connected to the AP MLD 104A, which may be in an SMD 202 with the AP MLD 104B (and other AP MLDs). The non-AP MLD 106 may determine that the non-AP MLD 106 should roam from the AP MLD 104A to the AP MLD 104B (e.g. due to proximity with the AP MLD 104B). The non-AP MLD 106 may communicate a link reconfiguration request 204 to the AP MLD 104A. The link reconfiguration request 204 may request that the AP MLD 104B add one or more links for the non-AP MLD 106 as part of roaming preparation. The link reconfiguration request 204 may be a UHR link reconfiguration request (e.g., a UHR variant of a link reconfiguration request). The link reconfiguration request 204 may include elements that are not included in traditional link reconfiguration requests (as used in 802.11be). For example, the link reconfiguration request 204 may include an SMDE that identifies the SMD 202 to which the AP MLD 104A and the AP MLD 104B belong. In some embodiments the SMDE may not be included in a UHR link reconfiguration request. As another example, the link reconfiguration request 204 may include a Multi-Link element (e.g., a reconfiguration multi-link element) that identifies the target AP MLD 104B (e.g., a MLD MAC address of the target AP MLD 104B) and a set of links to be added (and related parameters) at the target AP MLD 104B for roaming preparation. The reconfiguration multi-link element includes per-STA profile subelements to indicate one or more links that are requested to be added at the target AP MLD (using Link ID in the STA Control field), and includes complete profile information in the STA Profile field for the affiliated non-AP STA indicated in each per-STA profile subelement. In some embodiments, the set of links that are requested to be added at the target AP MLD in the reconfiguration multi-link element are indicated with a preference indication for those links. For example, the per-STA profile subelements are listed in a preference order (from most preferred to least preferred links or vice versa) in the reconfiguration multi-link element. In some embodiments, an explicit preference value is indicated for each requested link in the reconfiguration ML element, such as by including a preference field in each of the per-STA profile subelement (e.g., in the STA Info field with a corresponding presence bit in the STA Control field). In one case, a preference field may be a 4 or 5 or 6 or 8 bits field, with higher values indicating a higher preference (or inverse where lower values could indicate a higher preference). If preferences are indicated for requested links in the reconfiguration multi-link element, then the target AP MLD takes into account the indicated preferences when adding links at the target AP MLD for roaming preparation, where it prioritizes adding links based on their preference value when all requested links may not be added. As another example, the link reconfiguration request 204 may include a field indicating the type of roaming operation to be roaming preparation and may further include a roaming request control (or another element name) indicating configurations for different roaming options that the non-AP MLD 106 is requesting to prepare the AP MLD 104B for seamless roaming.

The AP MLD 104A receives the link reconfiguration request 204 and communicates some of the information in the link reconfiguration request 204 to the AP MLD 104B in a roaming context transfer request 206. The roaming context transfer request 206 may indicate to the AP MLD 104B to perform roaming preparation. The AP MLD 104B may set up one or more links 208 for the non-AP MLD 106 using the information in the roaming context transfer request 206. The links 208 may be inactive. The AP MLD 104B may reserve resources, such as for SCS and Block Acknowledgements for the non-AP MLD 106. The AP MLD 104B may then communicate a response 210 to the AP MLD 104A indicating that roaming preparation has been performed.

The AP MLD 104A may then communicate a link reconfiguration response 212 to the non-AP MLD 106. The link reconfiguration response 212 may be a UHR link reconfiguration response (a UHR variant of a link reconfiguration response) and may indicate to the non-AP MLD 106 that the AP MLD 104B has performed roaming preparation. The link reconfiguration response 212 may include elements that are not included in traditional link reconfiguration responses (as used in 802.11be). For example, the link reconfiguration response 212 may include an SMDE that identifies the SMD 202. In some embodiments the SMDE may not be included in a UHR link reconfiguration response. As another example, the link reconfiguration response 212 may include a Multi-Link element (e.g., a basic ML element) that identifies the target AP MLD 104B (e.g., using an AP MLD MAC address) that is prepared for roaming and identifies the set of links 208 that are setup (or added) at the target AP MLD 104B. The basic multi-link element includes per-STA Profile subelements for each added link with the complete profile information included in the STA Profile field for each per-STA profile subelement (e.g., the Complete Profile field is set to 1). As another example, the link reconfiguration response 212 may include a field indicating the type of roaming operation to be roaming preparation and may further include a roaming response control (or another element name) that indicates an outcome or status of the non-AP MLD 106 request to prepare the AP MLD 104B for roaming.

In some embodiments, the link reconfiguration response 212 may indicate a roaming preparation timeout field that indicates a timer duration after which the roaming preparation for the target AP MLD expires. The non-AP MLD 106 may start a timer 214 based on the roaming preparation timeout field after receiving the link reconfiguration response 212. Additionally, the target AP MLD 104B may start a similar timer (based on the roaming preparation timeout field with some timing adjustments applied) after sending the response 210, and the current AP MLD 104A may start a similar timer after sending the link reconfiguration response 212 (based on the roaming preparation timeout field). In some embodiments, the roaming preparation timeout is advertised and provided as a common SMD wide parameter by the AP MLD 104A and not sent in the link reconfiguration response 212. Roaming execution should be performed before the timer 214 expires. If the timer 214 expires without the non-AP MLD 106 initiating or performing roaming execution, the AP MLD 104B may remove or delete the links 208 for the non-AP MLD.

In certain embodiments, the non-AP MLD 106 may indicate that multiple AP MLDs should perform roaming preparation, indicating that the non-AP MLD 106 may roam to any of the multiple AP MLDs. The link reconfiguration request 204 may identify multiple AP MLDs (e.g., using multiple MAC addresses or identifiers for the target AP MLDs). The AP MLD 104A may communicate multiple roaming context transfer requests 206 to the multiple target AP MLDs. These target AP MLDs may prepare or add links for the non-AP MLD 106 and communicate responses 210 back to the AP MLD 104A. The AP MLD 104A may then communicate a link reconfiguration response 212 to the non-AP MLD 106 to indicate the target AP MLDs that have performed roaming preparation. The non-AP MLD 106 may then roam to any of these target AP MLDs by performing roaming execution.

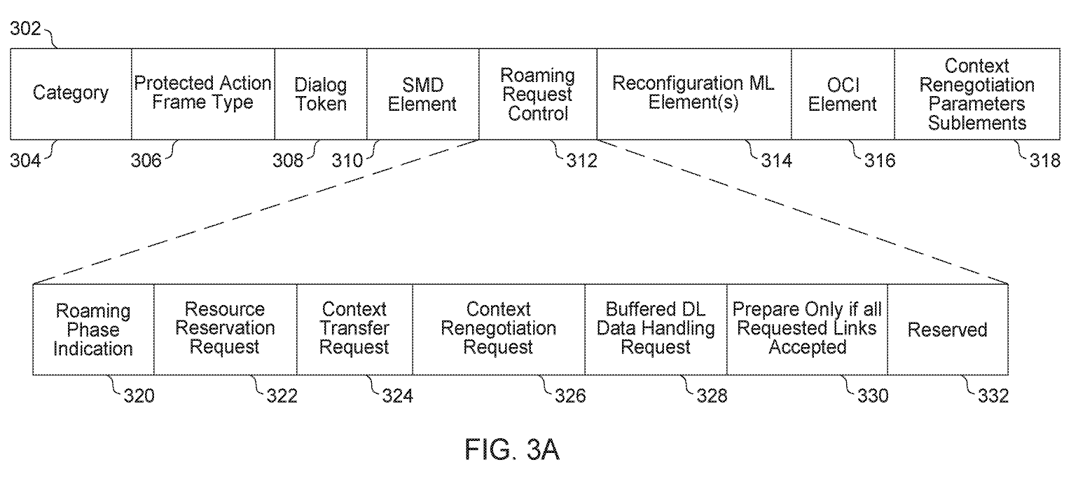

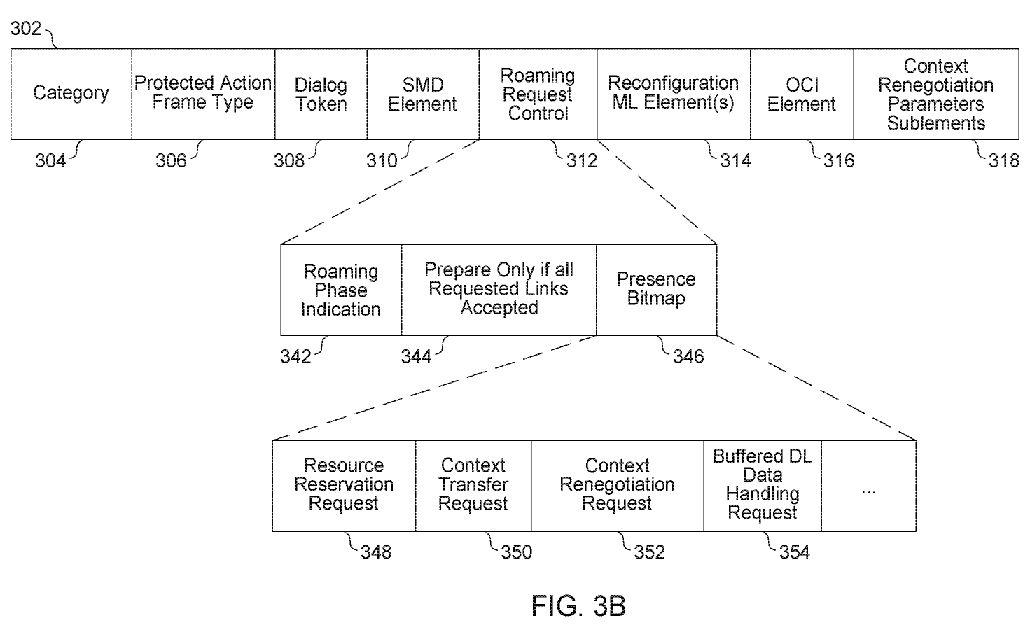

FIGS. 3A and 3B illustrate example messages 302 in the system 100 of FIG. 1A. Generally, the message 302 may be a link reconfiguration request (e.g., the link reconfiguration request 204 shown in FIG. 2) that a non-AP MLD (e.g., the non-AP MLD 106 shown in FIG. 1A) sends to a serving AP MLD (e.g., the AP MLD 104A shown in FIG. 1A) to initiate the roaming preparation process for a target AP MLD.

FIG. 3A provides a first example of the message 302. As seen in FIG. 3A, the message 302 includes multiple fields 304, 306, 308, 310, 312, 314, 316 and 318. The field 304 indicates a category for the message 302 which is an action frame, indicating the category for the action frame such as protected extremely high throughput (EHT) action or protected UHR action (when a UHR variant of the link reconfiguration request is used). The field 306 indicates a protected action frame type (e.g., link reconfiguration request or UHR link reconfiguration request) within the indicated category. The field 308 indicates a dialog token. The field 310 includes an SMDE that identifies an SMD for the serving AP MLD and the target AP MLD (e.g., using a MAC address for the SMD or an SMD Identifier). In some embodiments, the SMDE may not be included in a UHR link reconfiguration request. The field 312 includes roaming request control, which may include control information for the roaming preparation. The field 314 includes one or more reconfiguration ML elements, where each reconfiguration ML element may identify the target AP MLD in the common info field (e.g., using an MLD MAC address of the target AP MLD) and indicate a set of links (using per-STA profile subelements in the reconfiguration ML element) which are being requested to be added or setup at the target AP MLD for roaming preparation. The reconfiguration multi-link element includes per-STA profile subelements to indicate one or more links that are requested to be added at the target AP MLD (using Link ID in the STA Control field), and includes complete profile information in the STA Profile field for the affiliated non-AP STA indicated in each per-STA profile subelement. In some embodiments, the set of links that are requested to be added at the target AP MLD in the reconfiguration multi-link element are indicated with a preference indication for those links, as described above for 204. Multiple reconfiguration ML elements may be included when roaming preparation is requested for multiple target AP MLDs using a single link reconfiguration request/response exchange. If roaming preparation is performed for a single target AP MLD, then only one reconfiguration ML element is included. The field 316 includes an OCI element. The field 318 includes context renegotiation parameters subelements (or fields), which may indicate parameters requested for renegotiation or negotiation of context or agreements such as for block acknowledgement agreements, SCS agreements, mirrored stream classification services (MSCS) agreements, target wake time (TWT) agreements, traffic identifier-to-link (TID-to-link) mapping, etc.

Additionally, the roaming request control in the field 312 may include fields 320, 322, 324, 326, 328, 330, and 332. The field 320 includes a roaming phase indication. In this example, the field 320 may indicate that roaming preparation is being requested. In some embodiments the roaming phase indication or roaming operation type (e.g., indication for roaming preparation or roaming execution) may be indicated by a field outside the roaming request control (e.g., the roaming phase indication may be included in the message 302 but outside the field 312). The field 322 may include a resource reservation request, which may signal reservation for SCS resources or TWT resources. The field 324 includes a context transfer request, which may signal context transfer for block acknowledgement agreements, SCS agreements, MSCS agreements, etc. The field 326 may include a context renegotiation request, which may signal context renegotiation or negotiation for block acknowledgement agreements, SCS agreements, MSCS agreements, etc. The field 328 may include a buffered downlink (DL) data handling request, which may signal a preference of the non-AP MLD for buffered DL data handling (e.g., drain, forward, etc.). The field 330 may signal whether roaming should be prepared only if all requested links are accepted. The field 332 may be reserved for future use.

In some instances, the SMDE in the field 310 may signal a request for seamless roaming within the indicated SMD. Roaming preparation may be rejected if the SMDE does not match an advertised SMDE by the AP MLD 104A and 104B.

In some cases, the roaming request control in the field 312 may be an element or a field, including several subfields. In one format option, the roaming request control in the field 312 may include SMD information and the MAC address of the target AP MLD.

In a format option, the information in one or more of the fields 310, 312, and 314 may be integrated into one combined element.

The context renegotiation parameters subelements in the field 318 may include multiple subelements, one for each type of context to be negotiated.

In some embodiments, the message 302 may identify multiple target AP MLDs that should perform roaming preparation. The message 302 may include roaming request control and reconfiguration ML elements for multiple target AP MLDs. The ordering of the roaming request control and the reconfiguration ML elements may indicate a prioritization of the target AP MLDs. For example, if a reconfiguration ML element for a first target AP MLD appears in the message 302 before a reconfiguration ML element for a second target AP MLD, then it may indicate that the non-AP MLD has higher preference for preparing the first AP MLD over the second AP MLD for roaming preparation, which may be used to select which target AP MLDs to prepare in case network has limited resources. In some embodiments, the preference for target AP MLDs may be explicitly signaled in the message 302.

FIG. 3B provides a second example of the message 302. Similar to the example of FIG. 3A, the message 302 in FIG. 3B includes the fields 304, 306, 308, 310, 312, 314, 316, and 318. The field 304 indicates a category for the message 302 which is an action frame, indicating the category for the action frame such as protected EHT action or protected UHR action (when a UHR variant of the link reconfiguration request is used). The field 306 indicates a protected action frame type (e.g., link reconfiguration request or UHR link reconfiguration request) within the indicated category. The field 308 indicates a dialog token. The field 310 includes an SMDE that identifies an SMD for the serving AP MLD and the target AP MLD (e.g., using a MAC address for the SMD). In some embodiments, the SMDE may not be included in a UHR variant of the link reconfiguration request. The field 312 includes roaming request control, which may include control information for the roaming preparation. The field 314 includes one or more reconfiguration ML elements, where each reconfiguration ML element may identify the target AP MLD in the common info field (e.g., using an MLD MAC address of the target AP MLD) and indicate a set of links (using per-STA profile subelements in the reconfiguration ML element) which are being requested to be added or setup at the target AP MLD for roaming preparation. The reconfiguration multi-link element includes per-STA profile subelements to indicate one or more links that are requested to be added at the target AP MLD (using Link ID in the STA Control field), and includes complete profile information in the STA Profile field for the affiliated non-AP STA indicated in each per-STA profile subelement. In some embodiments, the set of links that are requested to be added at the target AP MLD in the reconfiguration multi-link element are indicated with a preference indication for those links, as described above for 204. Multiple reconfiguration ML elements may be included when roaming preparation is requested for multiple target AP MLDs using a single link reconfiguration request/response exchange. If roaming preparation is performed for a single target AP MLD, then only one reconfiguration ML element is included. The field 316 includes an OCI element. The field 318 includes context renegotiation parameters subelements, which may indicate parameters requested for renegotiation or negotiation of context or agreements such as block acknowledgement agreements, SCS agreements, MSCS agreements, TWT agreements, TID-to-link mapping, etc.

Additionally, the roaming request control in the field 312 may include fields 342, 344, and 346. The field 342 includes a roaming phase indication. In this example, the field 342 may indicate that roaming preparation is being requested. In some embodiments the roaming phase indication or roaming operation type (e.g., indication for roaming preparation or roaming execution) may be indicated by a field outside the roaming request control (e.g., the roaming phase indication may be included in the message 302 but outside the field 312). The field 344 may signal whether roaming should be prepared only if all requested links are accepted. The field 346 includes a presence bitmap that signals the presence of different types of request control for roaming. If a specific control is not signaled, then default behavior may be applied. The presence of some request control or configuration may be signaled using the presence bitmap (e.g. if larger size control) and other request control or configuration may be included and set accordingly without indication of a presence bit (e.g. if only few bits needed for the control).

In the example of FIG. 3B, the presence bitmap in the field 346 indicates the presence of fields 348, 350, 352, and 354 (where specific bits can indicate presence of these fields, the detailed format for the presence bitmap field 346 is not shown). The field 348 indicates a resource reservation request, which may signal reservation for SCS resources, MSCS resources or TWT resources. The field 350 indicates a context transfer request, which may signal context transfer for block acknowledgement agreements, SCS agreements, MSCS agreements, etc. The field 352 indicates a context renegotiation request, which may signal context renegotiation or negotiation for block acknowledgement agreements, SCS agreements, MSCS agreements, etc. The field 354 indicates a buffered DL data handling request, which may signal a preference of the non-AP MLD for buffered DL data handling (e.g., drain, forward, etc.). The roaming request control in the field 312 may include other requests, and the presence bitmap in the field 346 may indicate the presence of these requests.

In a format option, the information in one or more of the fields 310, 312, and 314 may be integrated into one combined element.

In some embodiments, the message 302 may identify multiple target AP MLDs that should perform roaming preparation. The message 302 may include roaming request control and reconfiguration ML elements for multiple target AP MLDs.

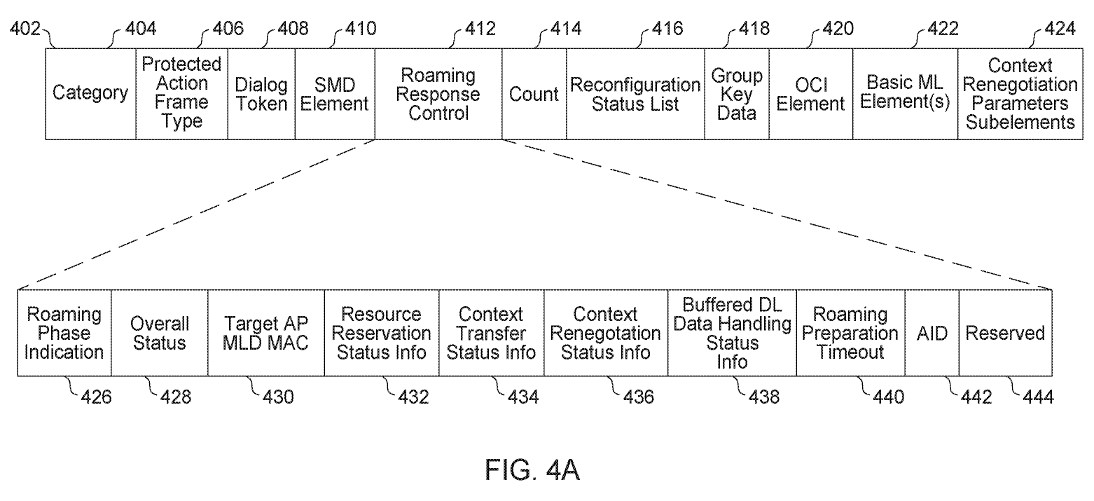

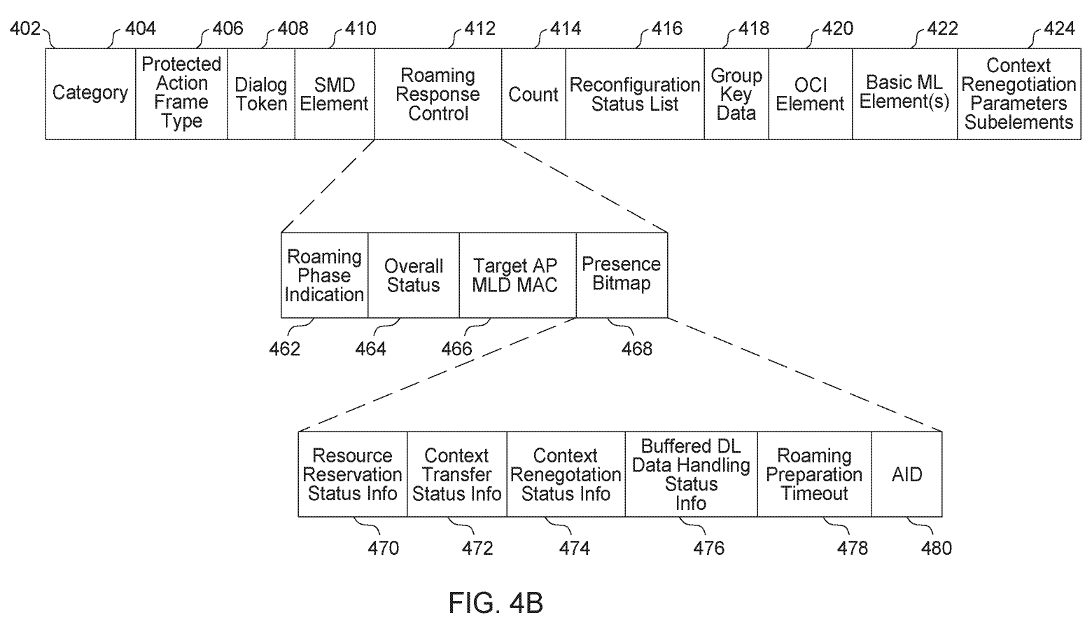

FIGS. 4A and 4B illustrate example messages 402 in the system 100 of FIG. 1A. Generally, the message 402 may be a link reconfiguration response (e.g., the link reconfiguration response 212 shown in FIG. 2) that a serving AP MLD (or a current AP MLD) (e.g., the AP MLD 104A shown in FIG. 1A) sends to a non-AP MLD (e.g., the non-AP MLD 106 shown in FIG. 1A) to signal the status or result of the roaming preparation.

FIG. 4A provides a first example of the message 402. As seen in FIG. 4A, the message 402 includes multiple fields 404, 406, 408, 410, 412, 414, 416418, 420, 422, and 424. The field 404 indicates a category for the message 402 which is an action frame, indicating the category for the action frame such as protected EHT action or protected UHR action (when a UHR variant of the link reconfiguration response is used). The field 406 indicates a protected action frame type (e.g., link reconfiguration response or UHR link reconfiguration response) within the indicated category. The field 408 indicates a dialog token. The field 410 includes an SMDE that identifies an SMD for the serving AP MLD and the target AP MLD (e.g., using a MAC address for the SMD). In some embodiments the SMDE may not be included in a UHR variant of the link reconfiguration response. The field 412 includes roaming response control, which may include control information for the roaming preparation. The field 414 includes a count, which may indicate a number of reconfiguration status duple fields included in the reconfiguration status list field 416. The field 416 may include a reconfiguration status list, which may include one or more reconfiguration status duple fields where each reconfiguration status duple field provides the status (accept or reject) for a link (identified by Link ID) that is requested to be setup at the target AP MLD for roaming preparation. The field 418 may include group key data, which provides group keys (e.g. GTK, IGTK, BIGTK) for accepted links of the target AP MLD. In some embodiments, the group key data field 418 is not included in the link reconfiguration response sent for the roaming preparation and may be included in the link reconfiguration response sent for roaming execution. In some embodiments, where group keys are provided in the link reconfiguration response sent for roaming preparation, the group keys for added links may be provided in another element (e.g., a Key Delivery element or another element) instead of a group key data field. The field 420 includes an OCI element. The field 422 may include one or more basic ML elements, where each basic ML element may identify the target AP MLD which is prepared for roaming in the common info field (e.g., using the MLD MAC address of the target AP MLD). Multiple basic ML elements may be included when roaming preparation is performed for multiple target AP MLDs using a single link reconfiguration request/response exchange. If roaming preparation is performed for a single target AP MLD, then only one basic ML element is included (if roaming preparation succeeds). The basic ML element includes per-STA Profile subelements for each added link, with complete profile information included in the STA Profile field for each per-STA profile subelement (e.g., the Complete Profile field is set to 1). The field 424 includes context renegotiation parameters subelements (or fields), which may indicate parameters (that are accepted or suggested by the target AP MLD) for the requested renegotiation or negotiation of context or agreements such as for block acknowledgement agreements, SCS agreements, MSCS agreements, TWT agreements, TID-to-link mapping, etc.

Additionally, the roaming response control in the field 412 may include fields 426, 428, 430, 432, 434, 436, 438, 440, 442, and 444. The field 426 includes a roaming phase indication. In this example, the field 426 may indicate that roaming preparation is being reported. In some embodiments the roaming phase indication or roaming operation type (e.g., indication for roaming preparation or roaming execution) may be indicated by a field outside the roaming response control (e.g., the roaming phase indication may be included in the message 402 but outside the field 412). The field 428 may indicate an overall status of the roaming preparation. In some embodiments, the overall status may be indicated by a field outside the roaming response control (e.g., the overall status indication may be included in the message 402 but outside the field 412). The overall status is indicated as Success if the roaming preparation succeeds with at least one link added at the target AP MLD. The field 430 may identify a target AP MLD (e.g., using the MLD MAC address of the target AP MLD), which may be optionally included. In some embodiments, when a single target AP MLD is being prepared, then the field 430 may not be included and the target AP MLD MAC Address may be provided as part of Basic ML element(s) field 422. The field 432 may include resource reservation status information, which may indicate the status and information of the requested resource reservation (e.g., for SCS resources, MSCS resources or TWT resources). The field 434 includes context transfer status information, which may indicate the status and information of the requested context transfer (e.g., for block acknowledgement agreements, SCS agreements, MSCS agreements etc.). The field 436 may include context renegotiation status information, which may indicate the status and information of the requested context renegotiation or negotiation (e.g., for block acknowledgement agreements, SCS agreements, MSCS agreements, etc.). The field 438 may include buffered DL data handling status info, which may indicate the status and information of buffered DL data delivery. The field 440 may include a roaming preparation timeout that indicates a timer duration after which the roaming preparation for the target AP MLD expires. The non-AP MLD should begin roaming execution before the timer expires. If the non-AP MLD does not perform roaming execution with the target AP MLD before the timer expires, the target AP MLD may remove or delete the link that the target AP MLD prepared for the non-AP MLD. The field 442 includes an AID, which indicates the AID assigned to the non-AP MLD by the target AP MLD. In some instances, the AID may be sent during roaming execution. The field 444 may be reserved for future use.

In some embodiments, the SMDE in the field 410 signals a response for seamless roaming within the indicated SMD. The message 402 may carry the same SMDE as in a corresponding link reconfiguration request.

In some instances, the roaming response control in the field 412 may be an element.

In some cases, the group key data in the field 418 or the AID in the field 442 may be provided during a roaming execution phase as opposed to a roaming preparation phase.

In one format, the information in one or more of the fields 410, 412, and 422 may be integrated into one combined element.

In some instances, the group key data in the field 418 may not be applicable to the roaming preparation phase and may be included in the link reconfiguration response sent for roaming execution.

FIG. 4B provides a second example of the message 402. Similar to the example of FIG. 4A, the message 402 in FIG. 4B includes the fields 404, 406, 408, 410, 412, 414, 416, 418, 420, 422, and 424. The field 404 indicates a category for the message 402 which is an action frame, indicating the category for the action frame such as protected EHT action or protected UHR action (when a UHR variant of the link reconfiguration response is defined). The field 406 indicates a protected action frame type (e.g., link reconfiguration response or UHR link reconfiguration response) within the indicated category. The field 408 indicates a dialog token. The field 410 includes an SMDE that identifies an SMD for the serving AP MLD and the target AP MLD (e.g., using a MAC address for the SMD). In some embodiments the SMDE may not be included in a UHR variant of the link reconfiguration response. The field 412 includes roaming response control, which may include control information for the roaming preparation. The field 414 includes a count, which may indicate a number of reconfiguration status duple fields included in the reconfiguration status list field 416. The field 416 may include a reconfiguration status list, which includes one or more reconfiguration status duple fields where each reconfiguration status duple field provides the status (accept or reject) for a link (identified by Link ID) that is requested to be setup at the target AP MLD for roaming preparation. The field 418 may include group key data, which provides group keys (e.g. GTK, IGTK, BIGTK) for accepted links of the target AP MLD. In some embodiments, the group key data field 418 is not included in the link reconfiguration response sent for the roaming preparation and may be included in the link reconfiguration response sent for roaming execution. In some embodiments, where group keys are provided in the link reconfiguration response sent for roaming preparation, the group keys for added links may be provided in another element (e.g., a Key Delivery element or another element) instead of a group key data field. The field 420 includes an OCI element. The field 422 may include one or more basic ML elements, where each basic ML element may identify the target AP MLD which is prepared for roaming in the common info field (e.g., using the MLD MAC address of the target AP MLD). Multiple basic ML elements may be included when roaming preparation is performed for multiple target AP MLDs using a single link reconfiguration request/response exchange. If roaming preparation is performed for a single target AP MLD, then only one basic ML element may be included (if roaming preparation succeeds). The basic ML element may include per-STA Profile subelements for each added link, with complete profile information included in the STA Profile field for each per-STA profile subelement (e.g., the Complete Profile field is set to 1). The field 424 includes context renegotiation parameters subelements (or fields), which may indicate parameters (that are accepted or suggested by the target AP MLD) for the requested renegotiation or negotiation of context or agreements such as for block acknowledgement agreements, SCS agreements, MSCS agreements, TWT agreements, TID-to-link mapping, etc.

Additionally, the roaming response control in the field 412 may include fields 462, 464, 466, and 468. The field 462 includes a roaming phase indication. In this example, the field 462 may indicate that roaming preparation is being reported. In some embodiments the roaming phase indication or roaming operation type (e.g., indication for roaming preparation or roaming execution) may be indicated by a field outside the roaming response control (e.g., the roaming phase indication may be included in the message 402 but outside the field 412). The field 464 may indicate an overall status of the roaming preparation. In some embodiments, the overall status may be indicated by a field outside the roaming response control (e.g., the overall status indication may be included in the message 402 but outside the field 412). The overall status is indicated as Success if the roaming preparation succeeds with at least one link added at the target AP MLD. The field 466 may identify a target AP MLD (e.g., using the MLD MAC address of the target AP MLD), which may be optionally included. In some embodiments, when a single target AP MLD is being prepared, then the field 466 may not be included and the target AP MLD MAC Address is provided as part of Basic ML element(s) field 422. The field 468 includes a presence bitmap that signals the presence of different types of response control for roaming.

In the example of FIG. 4B, the presence bitmap in the field 468 includes fields 470, 472, 474, 476, 478, and 480. The field 470 may include resource reservation status information, which may indicate the status and information of the requested resource reservation (e.g., for SCS resources, MSCS resources, or TWT resources). The field 472 includes context transfer status information, which may indicate the status and information of the requested context transfer (e.g., for block acknowledgement agreements, SCS agreements, MSCS agreements, etc.). The field 474 may include context renegotiation status information, which may indicate the status and information of the requested context renegotiation or negotiation (e.g., for block acknowledgement agreements, SCS agreements, MSCS agreements, etc.). The field 476 may include buffered DL data handling status info, which may indicate the status and information of buffered DL data delivery. The field 478 may include a roaming preparation timeout that indicates a timer duration after which the roaming preparation for the target AP MLD expires. The non-AP MLD should begin roaming execution before the timer expires. If the non-AP MLD does not perform roaming execution with the target AP MLD before the timer expires, the target AP MLD may remove or delete the link that the target AP MLD prepared for the non-AP MLD. The field 480 includes an AID, which indicates the AID assigned to the non-AP MLD by the target AP MLD. In some instances, the AID may be sent during roaming execution.

In some embodiments, the message 402 may identify multiple target AP MLDs that should perform roaming preparation. The message 402 may include roaming request control and reconfiguration ML elements for the target AP MLDs.

In some cases, the group key data in the field 418 or the AID in the field 480 may be provided during a roaming execution phase as opposed to a roaming preparation phase.

In some instances, if the roaming preparation fails, then the roaming preparation timeout in the field 478 is not provided or reserved.

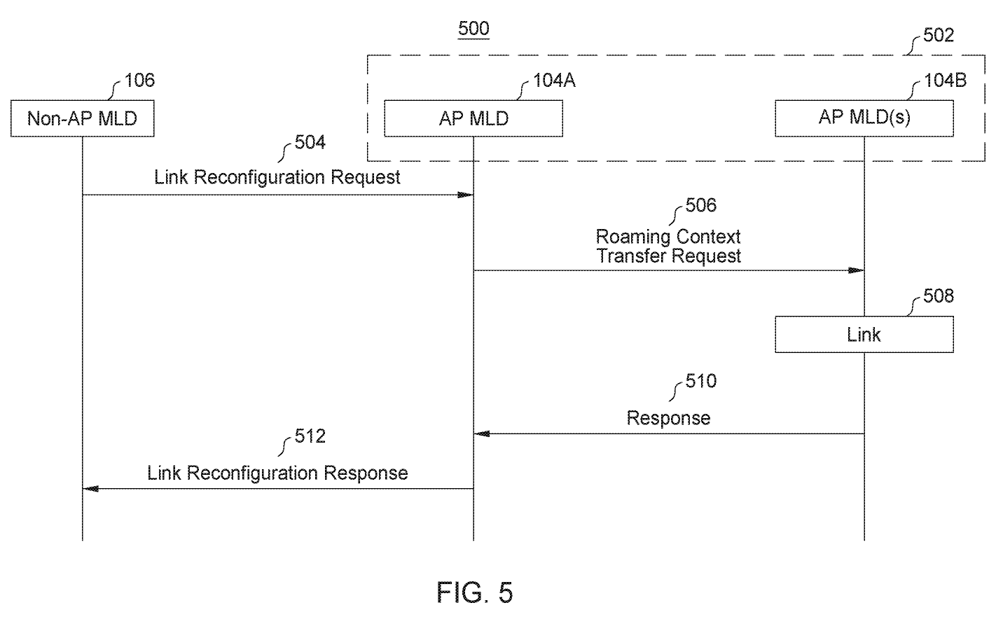

FIG. 5 illustrates an example operation 500 performed by the system 100 of FIG. 1A. As seen in FIG. 5, the non-AP MLD 106, the AP MLD 104A, and the AP MLD 104B perform the operation 500. By performing the operation 500, the non-AP MLD 106, the AP MLD 104A, and the AP MLD 104B use link reconfiguration requests and responses to perform roaming execution.

The non-AP MLD 106 may be connected to the AP MLD 104A, which may be in an SMD 502 with the AP MLD 104B (and other AP MLDs). The non-AP MLD 106 may have performed roaming preparation with the AP MLD 104B and may now be performing roaming execution. The non-AP MLD 106 may communicate a link reconfiguration request 504 to the AP MLD 104A. The link reconfiguration request 504 may signal a request for roaming execution. The link reconfiguration request 504 may be a UHR link reconfiguration request (a UHR variant of a link reconfiguration request) and may include elements that are not included in a traditional link reconfiguration request (as used in 802.11be). For example, the link reconfiguration request 504 may include an SMDE that identifies the SMD 502. In some embodiments the SMDE may not be included in a UHR link reconfiguration request. As another example, the link reconfiguration request 504 may include a multi-link element (e.g., a Reconfiguration ML element) that identifies the AP MLD 104B (e.g., using an MLD MAC address of the AP MLD 104B) as a target AP MLD for roaming execution. The Reconfiguration ML element included in the link reconfiguration request for roaming execution may not include per-STA Profile subelements, because links are already added at the target AP MLD as part of roaming preparation. As another example, the link reconfiguration request 504 may include a roaming request control, which may include control information for the roaming execution to the target AP MLD 104B. As another example, the link reconfiguration request 504 may include a roaming phase indication which indicates roaming execution.

The AP MLD 104A receives the link reconfiguration request 504 and communicates some of the information in the link reconfiguration request 504 to the AP MLD 104B in a roaming context transfer request 506. The roaming context transfer request 506 may indicate to the AP MLD 104B to perform roaming execution. The roaming context transfer request 506 for roaming execution may carry fields and parameters related to roaming execution (e.g., a field indicating roaming phase to be roaming execution, dynamic context information (such as SN and PN) for the non-AP MLD 106, etc.).

The AP MLD 104B may activate a link 508 for the non-AP MLD 106 that was previously added during roaming preparation using the information in the roaming context transfer request 506. In some instances, the AP MLD 104B may open or unblock an IEEE 802.1X controlled port and initiate a DS mapping update for the non-AP MLD 106. The AP MLD 104B may then communicate a response 510 to the AP MLD 104A indicating that roaming execution has been performed.

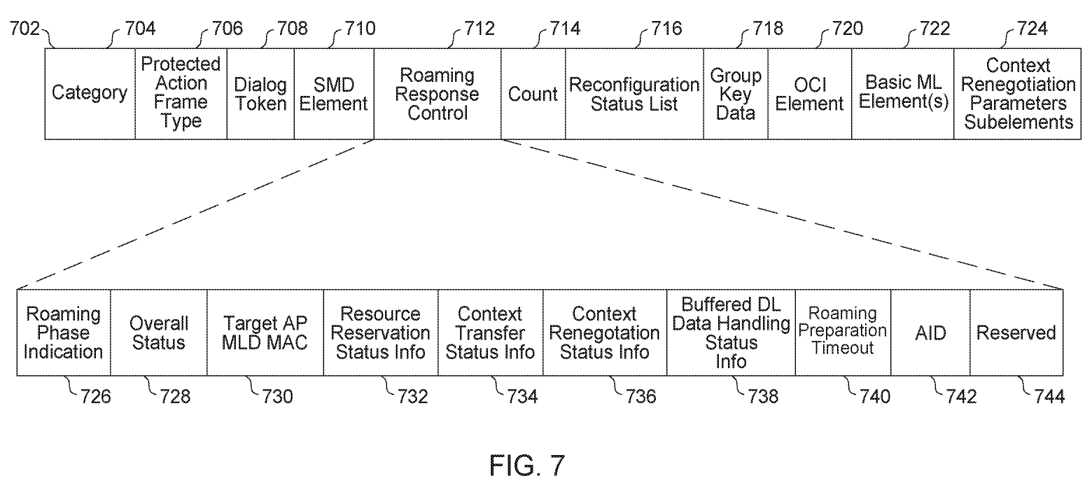

The AP MLD 104A may then communicate a link reconfiguration response 512 to the non-AP MLD 106. The link reconfiguration response 512 may indicate to the non-AP MLD 106 that the AP MLD 104B has completed roaming execution and is ready to connect with the non-AP MLD 106. The link reconfiguration response 512 may be a UHR link reconfiguration response (a UHR variant of a link reconfiguration response) and may include elements that are not included in a traditional link reconfiguration response (as used in 802.11be). For example, the link reconfiguration response 512 may include an SMDE that identifies the SMD 502. In some embodiments the SMDE may not be included in a UHR link reconfiguration response. As another example, the link reconfiguration response 512 may include a Basic ML element that identifies the AP MLD 104B (e.g., using an AP MLD MAC address) with which roaming execution is performed. In some embodiments, the Basic ML element may not indicate any per-STA profile subelements to indicate per-link information because the set of added links (and per-link detailed profile information) are already provided as part of the basic ML element (that includes per-STA profile subelements) during the roaming preparation in the link reconfiguration response 212. In another alternate embodiment, the Basic ML element may indicate (or confirm) the set of links that are setup at the target AP MLD 104B (for the non-AP MLD) by including a per-STA profile subelement for each of the setup links. In this case, the Basic ML element would indicate the set of links that are added as part of roaming preparation by including a per-STA profile subelement for each of the added links. In each per-STA profile subelement, the Link ID information may be provided to indicate the added link and detailed per-link profile information (fields or elements) may not be provided in the STA Profile field (because detailed per-link profile information is already provided in the basic ML element during roaming preparation procedure). Other embodiments are possible related to basic ML element in the link reconfiguration response 512 as described below for FIG. 7. As another example, the link reconfiguration response 512 may include roaming response control that indicates an outcome of the roaming execution. As another example, the link reconfiguration response 512 may include a roaming phase indication which indicates roaming execution.

In some instances, the roaming execution may be performed using the link reconfiguration request 504 and the link reconfiguration response 512 even without the non-AP MLD 106, the AP MLD 104A, and the AP MLD 104B performing roaming preparation, in which case the roaming preparation and roaming execution procedures are combined into one single step. For single step roaming execution, the link reconfiguration request 504 and the link reconfiguration response 512 may be sent to a serving AP MLD (e.g. AP MLD 104A) or may be sent directly to the target AP MLD (e.g. AP MLD 104B).

In some cases, link setup and most static context are transferred or renegotiated during the roaming preparation phase. The roaming execution phase may be kept simple with minimal dynamic context transfer. If links are already setup and most context transferred, then context renegotiation may not be allowed during roaming execution. Signalling related to dynamic context transfer may be allowed during roaming execution. If in some cases, roaming preparation was not done in advance, then the functionality of roaming preparation would be done during the roaming execution phase. In this case, link setup, static context transfer, resource reservation, and context renegotiation may be performed in the roaming execution phase.

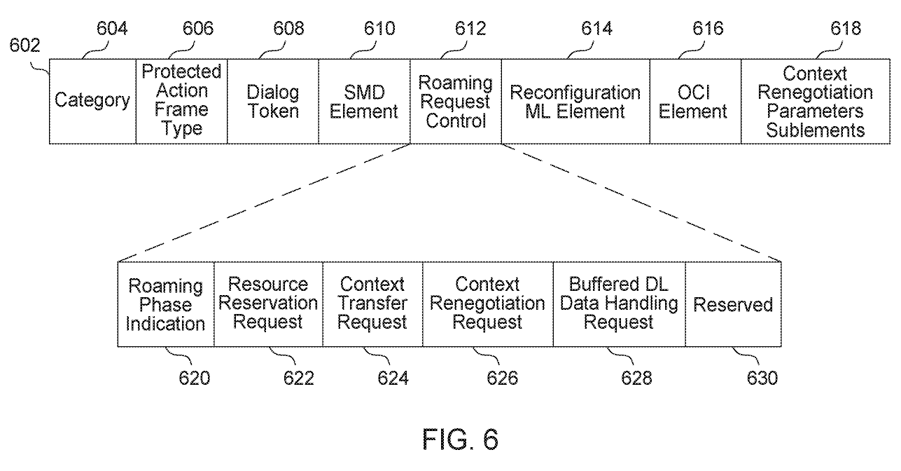

FIG. 6 illustrates an example message 602 in the system of FIG. 1A. Generally, the message 602 may be a link reconfiguration request (e.g., the link reconfiguration request 504 shown in FIG. 5) that a non-AP MLD (e.g., the non-AP MLD 106 shown in FIG. 1A) sends to a serving AP MLD (e.g., the AP MLD 104A shown in FIG. 1A) to initiate the roaming execution process for a target AP MLD (e.g., the AP MLD 104B shown in FIG. 1A).

As seen in FIG. 6, the message 602 includes multiple fields 604, 606, 608, 610, 612, 614, 616 and 618. The field 604 indicates a category for the message 602, which is an action frame, indicating the category for the action frame such as protected EHT action or protected UHR action (when a UHR variant of the link reconfiguration request is defined). The field 606 indicates a protected action frame type (e.g., link reconfiguration request or UHR link reconfiguration request) within the indicated category. The field 608 indicates a dialog token. The field 610 includes an SMDE that identifies an SMD for the serving AP MLD and the target AP MLD (e.g., using a MAC address for the SMD or an SMD identifier). In some embodiments the SMDE may not be included in a UHR link reconfiguration request. The field 612 includes roaming request control, which may include control information for the roaming execution. The field 614 includes a reconfiguration ML element, which may identify the target AP MLD in the common info field (e.g., using an MLD MAC address of the target AP MLD). The field 616 includes an OCI element. The field 618 includes context renegotiation parameters subelements (or fields), which may indicate parameters requested for renegotiation or negotiation of context or agreements such as for block acknowledgement agreements, SCS agreements, MSCS agreements, TWT agreements, TID-to-link mapping, etc.

Additionally, the roaming request control in the field 612 may include fields 620, 622, 624, 626, 628, and 630. The field 620 includes a roaming phase indication. In this example, the field 620 may indicate that roaming execution is being requested. In some embodiments the roaming phase indication or roaming operation type (e.g., indication for roaming preparation or roaming execution) may be indicated by a field outside the roaming request control (e.g., the roaming phase indication may be included in the message 602 but outside the field 612). The field 622 may include a resource reservation request, which may signal reservation for SCS resources or TWT resources. The field 624 includes a context transfer request, which may signal context transfer for block acknowledgement agreements, SCS agreements, MSCS agreements, etc. The field 626 may include a context renegotiation request, which may signal context renegotiation or negotiation for block acknowledgement agreements, SCS agreements, MSCS agreements, etc. The field 628 may include a buffered DL data handling request, which may signal a preference of the non-AP MLD for buffered DL data handling (e.g., drain, forward, etc.). The field 630 may be reserved for future use.

In some embodiments, the message 602 may not include the context renegotiation parameters subelements in the field 618, the resource reservation request in the field 622, or the context renegotiation request in the field 626, because these fields may not apply for roaming execution.

In some instances, the SMDE in the field 610 may signal a request for seamless roaming within the indicated SMD. Roaming execution may be rejected if the SMDE does not match an advertised SMDE by the serving AP MLD and the target AP MLD.

In some cases, the roaming request control in the field 612 may be an element or a field. Some parts of this element or field may be inapplicable for roaming execution. For example, the resource reservation request in the field 622 and the context renegotiation request in the field 626 may be inapplicable. In one format option, the roaming request control may include SMD information and a MAC address of the target AP MLD.

The buffered DL data handling configuration may be indicated at roaming execution phase or even earlier at the roaming preparation phase.

In a format option, the information in one or more of the fields 610, 612, and 614 may be integrated into one combined element.

FIG. 7 illustrates an example message 702 in the system 100 of FIG. 1A. Generally, the message 702 may be a link reconfiguration response (e.g., the link reconfiguration response 512 shown in FIG. 5) that a serving AP MLD (e.g., the AP MLD 104A shown in FIG. 1A) sends to a non-AP MLD (e.g., the non-AP MLD 106 shown in FIG. 1A) to signal the status or result of the roaming execution.

As seen in FIG. 7, the message 702 includes multiple fields 704, 706, 708, 710, 712, 714, 716718, 720, 722, and 724. The field 704 indicates a category for the message 702, which is an action frame, indicating the category for the action frame such as protected EHT action or protected UHR action (when a UHR variant of the link reconfiguration response is defined). The field 706 indicates a protected action frame type (e.g., link reconfiguration response or UHR link reconfiguration response) within the indicated category. The field 708 indicates a dialog token. The field 710 includes an SMDE that identifies an SMD for the serving AP MLD and the target AP MLD (e.g., using a MAC address for the SMD). In some embodiments the SMDE may not be included in a UHR variant of the link reconfiguration response. The field 712 includes roaming response control, which may include control information for the roaming execution. The field 714 includes a count, which may indicate a number of reconfiguration status duple fields included in the reconfiguration status list field 716 n. The field 716 may include a reconfiguration status list, which includes one or more reconfiguration status duple fields (based on the value of the count field) where each reconfiguration status duple field provides the status (accept/success or reject) for each link that is setup at the target AP MLD for the non-AP MLD. In one embodiment, the count field is set to the number of successfully added links at the target AP MLD during roaming preparation and each reconfiguration status duple in the reconfiguration status list field 716 indicates a success status for one of those added links. For example, the reconfiguration status list field 716 may confirm that the links that were added during roaming preparation are still successfully added at the target AP MLD for the non-AP MLD. In another embodiment, assuming that links prepared at the target AP MLD do not change during roaming execution, there may be no need to reconfirm the set of links added at roaming preparation again, and then the count field 714 is set to 0 and no reconfiguration status list field may be included.

The field 718 may include group key data, which provides group keys (e.g. GTK, IGTK, BIGTK) for links added at the target AP MLD for the non-AP MLD. In some embodiments, the group key data field 718 is included in the link reconfiguration response sent for roaming execution, and not included in the link reconfiguration response sent for roaming preparation. In some embodiments, the group keys for added links may be provided in another element in the message 702 (e.g., a Key Delivery element or another element) instead of in a group key data field. The field 720 includes an OCI element. The field 722 may include a basic ML element, which may identify a target AP MLD with which roaming execution is performed in the common info field (e.g., using an MLD MAC address of the target AP MLD). In one embodiment, the basic ML element in 722 may provide the target AP MLD MAC address and may not include per-STA profile subelements for added links (because that information is already provided during roaming preparation). In another embodiment, the Basic ML element may provide per-STA profile subelements for added links (e.g., to indicate (or confirm) the set of links that are setup at the target AP MLD 104B (for the non-AP MLD)). In this case the Basic ML element would indicate (or confirm) the set of links that were added as part of roaming preparation by including a per-STA profile subelement for each of the added links. In each per-STA profile subelement, the Link ID information may be provided to indicate the added link and detailed per-link profile information (fields or elements) may not be provided in the STA Profile field.

In some other embodiments, the Basic ML element may provide a latest set of AP/link profile information (or parameters) for the links that are added at the target AP MLD (for the non-AP MLD) by including one or more per-STA profile subelements for the added links, and provide per-link/AP profile information in the STA Profile field. In one embodiment, the per-STA profile subelements or STA Profile field in each per-STA profile subelement are included in the basic ML element in 722 only if AP/link parameters have been updated for the added links since roaming preparation. If included, the STA Profile field in the per-STA profile subelements included in the basic ML element may carry full profile information or partial profile information for the corresponding AP/link (indicated by the Complete Profile field). In case of partial profile information, the STA Profile field in the per-STA profile subelement may provide a list of fields and/or one or more elements providing updated set of BSS parameters for the corresponding AP/link since roaming preparation. In some embodiments, the basic ML element may include STA Profile field or per-STA profile subelements only for those added links for which AP/link profile information (or parameters) have been updated since roaming preparation (e.g., include per-STA profile subelements only for a subset of added links). In one embodiment, the determination of whether to include per-STA profile subelements or STA Profile information within the per-STA profile subelements in the basic ML element is made by the target AP MLD based on conditions such as updates to AP/link parameters, overhead reduction, or implementation simplicity. In one embodiment, the basic ML element may indicate the set of added links in per-STA Profile subelements but does not include STA Profile information unless any updated AP/link parameters should be provided.

In some embodiments, because the set of links and detailed parameters for the links that are added at the target AP MLD is already exchanged as part of roaming preparation, the basic ML element field 722 may not be included in the message 702, or included to provide the target AP MLD MAC address for roaming execution. In the latter case, other fields (other than the MLD MAC Address) in the common info field of the Basic Multi-Link element may not be included and their corresponding presence bits are set to zero.

The field 724 includes context renegotiation parameters subelements (or fields), which may indicate parameters (that are accepted or suggested by the target AP MLD) for the requested renegotiation or negotiation of context or agreements such as for block acknowledgement agreements, SCS agreements, MSCS agreements, TWT agreements, TID-to-link mapping, etc.

Additionally, the roaming response control in the field 712 may include fields 726, 728, 730, 732, 734, 736, 738, 740, 742, and 744. The field 726 includes a roaming phase indication. In this example, the field 724 may indicate that roaming execution is being reported. In some embodiments the roaming phase indication or roaming operation type (e.g., indication for roaming preparation or roaming execution) may be indicated by a field outside the roaming response control (e.g., the roaming phase indication may be included in the message 702 but outside the field 712). The field 728 may indicate an overall status of the roaming execution. In some embodiments, the overall status may be indicated by a field outside the roaming response control (e.g., the overall status indication may be included in the message 702 but outside the field 712). The overall status is indicated as success if the roaming execution succeeds for the target AP MLD. The field 730 may identify a target AP MLD (e.g., using the MLD MAC address of the target AP MLD), which may not be included if the target AP MLD MAC address is provided in the Basic ML element(s) field 722. The field 732 may include resource reservation status information, which may indicate the status and information of the requested resource reservation (e.g., for SCS resources or TWT resources). The field 734 includes context transfer status information, which may indicate the status and information of the requested context transfer (e.g., for block acknowledgement agreements, SCS agreements, etc.). The field 736 may include context renegotiation status information, which may indicate the status and information of the requested context renegotiation (e.g., for block acknowledgement agreements, SCS agreements, MSCS agreements, etc.). The field 738 may include buffered DL data handling status info, which may indicate the status and information of buffered DL data delivery. The field 740 may include a roaming preparation timer, which may indicate a value for a timer. The field 742 includes an AID, which indicates the AID assigned to the non-AP MLD by the target AP MLD. In some instances, the AID may be sent during roaming preparation and hence is not included in link reconfiguration response for roaming execution. The field 744 may be reserved for future use.

In some embodiments, the message 702 may not include the resource reservation status information in the field 732, the context renegotiation status information in the field 736, or the roaming preparation timeout in the field 740, because these fields may not apply for roaming execution.

In some embodiments, the SMDE in the field 710 signals a response for seamless roaming within the indicated SMD. The message 702 may carry the same SMDE as in a previous request.

In some instances, the roaming response control in the field 712 may be an element.

In some cases, the group key data in the field 718 may be provided during a roaming execution phase as opposed to a roaming preparation phase.

In one format, the information in one or more of the fields 710, 712, and 722 may be integrated into one combined element.

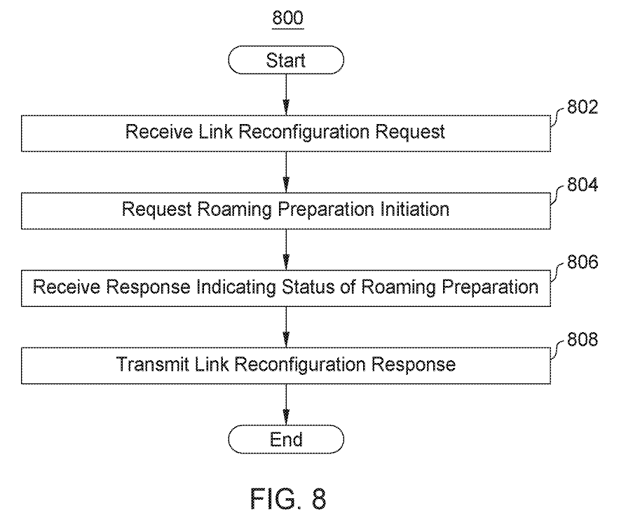

FIG. 8 is a flowchart of an example method 800 performed by the system 100 of FIG. 1A. In some embodiments, a serving AP MLD (e.g., the AP MLD 104A shown in FIG. 1A) performs the method 800. By performing the method 800, the serving AP MLD uses link reconfiguration requests and link reconfiguration responses to perform roaming preparation.

At 802, the serving AP MLD receives a link reconfiguration request from a non-AP MLD. The link reconfiguration request may identify an SMD of the serving AP MLD and a target AP MLD in the SMD. The link reconfiguration request may also include a roaming request control that indicates that the non-AP MLD is requesting to perform roaming preparation to the target AP MLD and other roaming context information as described above.

At 804, the serving AP MLD requests that the target AP MLD initiate roaming preparation. For example, the serving AP MLD may transmit roaming context information and parameters to the target AP MLD (e.g., in a roaming context transfer request).

At 806, the AP MLD receives a response from the target AP MLD indicating the outcome or status of the roaming preparation (e.g. success or failure and if success the set of links added at the target AP MLD). For example, a success status indicates that the roaming preparation was successful and that the target AP MLD has added a link for the non-AP MLD.

At 808, the AP MLD transmits a link reconfiguration response to the non-AP MLD. The link reconfiguration response may identify the SMD and the target AP MLD. The link reconfiguration response may also include a roaming response control that indicates an outcome of the roaming preparation.

In an embodiment, the link reconfiguration request may carry the add link information in a new ML element that includes a Common Info (with Target AP MLD MAC address) and provides a Per-station (STA) or device Profile with the information for links to be setup with a Target AP MLD MAC address (in place of using the Reconfiguration ML element). This element may also include information that is part of the roaming request control or the SMDE (partial SMD info may be included e.g. only the SMD Identifier). Alternatively, the SMD info may be in a separate element included in the request frame.

In one embodiment, the link reconfiguration response may carry the information returned for added links at the Target AP MLD in a new ML element that includes a Common Info (e.g., with Target AP MLD MAC address) and provides a Per-STA or device Profile with the information for links that are added at the Target AP MLD (e.g., in place of using the Basic ML element). This element may also include information that is part of the roaming response control or the SMDE (partial SMD info may be included e.g. only the SMD Identifier). Alternatively, the SMD info may be in a separate element included in the response frame.

SMD information included in the roaming request or response frames may be partial set of SMD info e.g. only the SMD Identifier without including SMD capabilities aspects.

In all the cases described above, the link reconfiguration request may be an EHT defined link reconfiguration request frame or a UHR link reconfiguration request frame (defined by UHR), and the link reconfiguration response may be an EHT defined link reconfiguration response frame or a UHR link reconfiguration response frame (defined by UHR).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A first access point multi-link device (AP MLD) comprising:
one or more memories; and
one or more processors communicatively coupled to the one or more memories, the one or more processors configured to, individually or collectively, perform an operation comprising:
receiving, from a non-access point multi-link device (non-AP MLD), a first link reconfiguration request comprising:
a first multi-link element that indicates a second AP MLD in a seamless mobility domain (SMD) of the first AP MLD and that indicates one or more links requested to be added at the second AP MLD for roaming preparation;
a first roaming phase indication that indicates a roaming preparation phase; and
a roaming request control indicating roaming context information from the non-AP MLD for roaming preparation at the second AP MLD; and
based on the first link reconfiguration request, requesting the second AP MLD to initiate roaming preparation using the first multi-link element, the first roaming phase indication, and the roaming request control.

2. The first AP MLD of claim 1, wherein the first link reconfiguration request further comprises an SMD element that identifies the SMD and comprises a media access control (MAC) address of the SMD.

3. The first AP MLD of claim 1, wherein the first multi-link element comprises an MLD MAC address of the second AP MLD.

4. The first AP MLD of claim 1, wherein the roaming request control indicates requests from the non-AP MLD for one or more of:
resource reservation at the second AP MLD;
context transfer to the second AP MLD;
context negotiation with the second AP MLD;
providing preferences of the non-AP MLD for roaming links preparation; and
providing preferences of the non-AP MLD for buffered downlink (DL) data handling.

5. The first AP MLD of claim 1, wherein the first link reconfiguration request comprises a context renegotiation parameters subelement that indicates a parameter for context to be renegotiated during roaming preparation.

6. The first AP MLD of claim 1, where the operation comprises transmitting, to the non-AP MLD, a link reconfiguration response comprising:
a second multi-link element that indicates the second AP MLD and the one or more links added at the second AP MLD for the non-AP MLD;
a second roaming phase indication that indicates the roaming preparation phase; and
a roaming response control that indicates an outcome of the roaming preparation requested by the non-AP MLD at the second AP MLD.

7. The first AP MLD of claim 6, wherein the link reconfiguration response further comprises an SMD element that identifies the SMD and comprises a MAC address of the SMD.

8. The first AP MLD of claim 6, wherein the second multi-link element comprises an MLD MAC address of the second AP MLD.

9. The first AP MLD of claim 6, wherein the roaming response control comprises an association identifier (AID) assigned to the non-AP MLD by the second AP MLD.

10. The first AP MLD of claim 6, wherein the first link reconfiguration request is a UHR link reconfiguration request and wherein the link reconfiguration response is a UHR link reconfiguration response.

11. The first AP MLD of claim 1, wherein the operation comprises:
receiving, from the non-AP MLD, a second link reconfiguration request to execute a roam to the second AP MLD; and
transmitting, to the non-AP MLD, a link reconfiguration response indicating an outcome of executing the roam to the second AP MLD.

12. The first AP MLD of claim 11, wherein:
the second link reconfiguration request comprises a second roaming phase indication that indicates a roaming execution phase; and
the link reconfiguration response comprises a roaming phase indication that indicates the roaming execution phase.

13. The first AP MLD of claim 11, wherein the link reconfiguration response comprises a set of group keys corresponding to the one or more links added at the second AP MLD for the non-AP MLD.

14. The first AP MLD of claim 11, wherein the second link reconfiguration request is a UHR link reconfiguration request and wherein the link reconfiguration response is a UHR link reconfiguration response.

15. A method comprising:
receiving, by a first access point multi-link device (AP MLD) and from a non-access point multi-link device (non-AP MLD), a first link reconfiguration request comprising:
a first multi-link element that indicates a second AP MLD in a seamless mobility domain (SMD) of the first AP MLD and that indicates one or more links requested to be added at the second AP MLD for roaming preparation;
a first roaming phase indication that indicates a roaming preparation phase; and
a roaming request control indicating roaming context information from the non-AP MLD for roaming preparation at the second AP MLD; and
based on the first link reconfiguration request, requesting, by the first AP MLD, the second AP MLD to initiate roaming preparation using the first multi-link element, the first roaming phase indication, and the roaming request control.

16. The method of claim 15, wherein the first link reconfiguration request further comprises an SMD element that identifies the SMD and comprises a media access control (MAC) address of the SMD.

17. The method of claim 15, wherein the first multi-link element comprises a MAC address of the second AP MLD.

18. The method of claim 15, wherein the roaming request control indicates requests from the non-AP MLD for one or more of:
resource reservation at the second AP MLD;
context transfer to the second AP MLD;
context negotiation with the second AP MLD;
providing preferences of the non-AP MLD for roaming links preparation; and
providing preferences of the non-AP MLD for buffered downlink (DL) data handling.

19. The method of claim 15, wherein the first link reconfiguration request comprises a context renegotiation parameters subelement that indicates a parameter for context to be renegotiated during roaming preparation.

20. A non-transitory computer readable medium storing instructions that, when executed, cause one or more processors to, individually or collectively, perform an operation comprising:
receiving, by a first access point multi-link device (AP MLD) and from a non-access point multi-link device (non-AP MLD), a first link reconfiguration request comprising:
a first multi-link element that indicates a second AP MLD in a seamless mobility domain (SMD) of the first AP MLD and that indicates one or more links requested to be added at the second AP MLD for roaming preparation;
a first roaming phase indication that indicates a roaming preparation phase; and
a roaming request control indicating roaming context information from the non-AP MLD for roaming preparation at the second AP MLD; and
based on the first link reconfiguration request, requesting, by the first AP MLD, the second AP MLD to initiate roaming preparation using the first multi-link element, the first roaming phase indication, and the roaming request control.
